(19) United States
(12) Patent Application Publication
(10) Pub. No.: US 2019/0092542 A1
(43) Pub. Date: Mar. 28, 2019

(54) SAFETY BUCKLE FOR FASTENING STRIP

(71) Applicant: YEN-CHU HUANG, Yunlin County (TW)

(72) Inventor: YEN-CHU HUANG, Yunlin County (TW)

(21) Appl. No.: 16/133,218

(22) Filed: Sep. 17, 2018

(30) Foreign Application Priority Data
Sep. 26, 2017 (TW) 106132930

(51) Int. Cl. B65D 63/16; F16B 2/08

(52) U.S. Cl. CPC B65D 63/16; F16L 3/2338; F16B 2/08

(57) ABSTRACT

A buckle for securing a fastening strip as a loop includes a base portion, a supporting portion above the base portion, a passageway formed between the base portion and the supporting portion, a first pressing portion connected to the base portion; and a second pressing portion connected to the base portion. An end of the fastening strip is connected to the base portion, and an opposite end of the fastening strip passes through the passageway and winds around a good to be fastened. Next, the fastening strip is bent to pass through the buckle for a couple of times to be supported by the supporting portion and pressed by the first and the second pressing portions.

### BACKGROUND OF THE INVENTION

### 1. Technical Field

The present invention relates to a fastening device, and more particularly to a buckle for securing a fastening strip as a loop.

### 2. Description of Related Art

Typically, when a worker wants to fasten a plurality of metallic pipes, he/she gathers the metallic pipes together and winds a metallic strip around them, and then the metallic strip is fastened by a buckle.

When the metallic strip is fastened by the buckle, the metallic strip has a free end suspended. Sometime, the free end of the metallic strip may hurt people.

The conventional buckle and metallic strip are applied to fasten a plurality of plastic pipes as well.

### BRIEF SUMMARY OF THE INVENTION

In view of the above, the primary objective of the present invention is to provide a buckle for securing a fastening strip as a loop, which secures the fastening strip and leaves no free end of the fastening strip.

The secondary objective of the present invention is to provide a buckle for securing a fastening strip as a loop, which keeps the end of fastening strip flat to reduce the risk of cutting people.

In order to achieve the objectives of the present invention, a buckle, which is adapted to secure a fastening strip, includes a base portion; a supporting portion, which is above the base portion, wherein a passageway is formed between the base portion and the supporting portion, and the passageway has a first opening and a second opening at opposite ends thereof; a first pressing portion connected to the base portion; and a second pressing portion connected to the base portion.

An end of the fastening strip is connected to the base portion, and an opposite end of the fastening strip passes through the passageway and winds around a good and arrives at an opposite ends of the buckle. Next, the fastening strip passes through the buckle, and is attached on the supporting portion. Next, the fastening strip is bent for 180 degrees to pass the buckle again, and the first pressing portion is bent to press the fastening strip thereunder. The fastening strip is bent for 180 degrees again to pass the buckle, and the second pressing portion is bent to press the fastening strip thereunder.

### BRIEF DESCRIPTION OF THE SEVERAL VIEWS OF THE DRAWINGS

The present invention will be best understood by referring to the following detailed description of some illustrative embodiments in conjunction with the accompanying drawings, in which

FIG. 1 is a sketch diagram of a first preferred embodiment of the present invention, showing the fastening strip working with the buckle to fasten the pipes;

FIG. 2 is a perspective view of the first preferred embodiment of the present invention;

FIG. 3 is a right view of the first preferred embodiment of the present invention;

FIG. 4 is a perspective view of the first preferred embodiment of the present invention, showing the fastening strip passing through the buckle;

FIG. 5 to FIG. 8 are sketch diagrams of the first preferred embodiment of the present invention, showing how to secure the fastening strip with the buckle;

FIG. 9 is a perspective view of a second preferred embodiment of the present invention; and

FIG. 10 is a perspective view of a third preferred embodiment of the present invention.

### DETAILED DESCRIPTION OF THE INVENTION

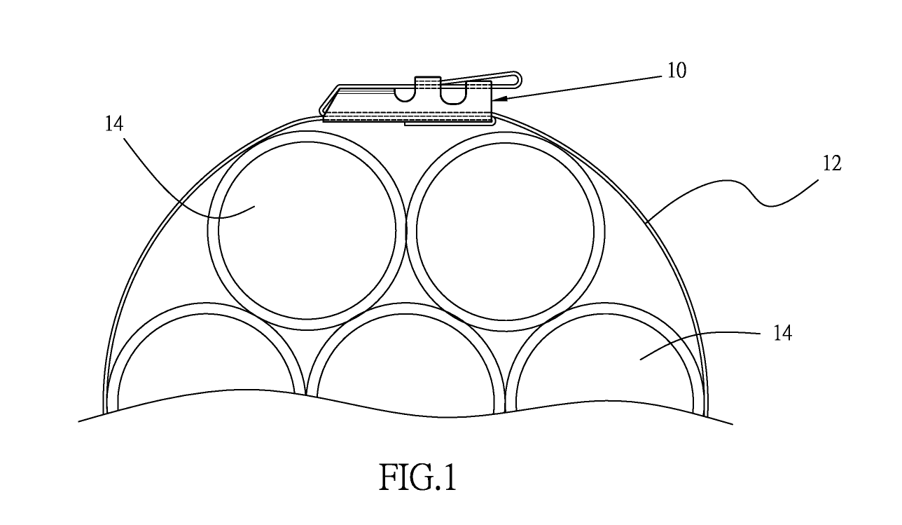

FIG. 1 shows a buckle 10 working with a fastening strip 12 to fasten a plurality of pipes.

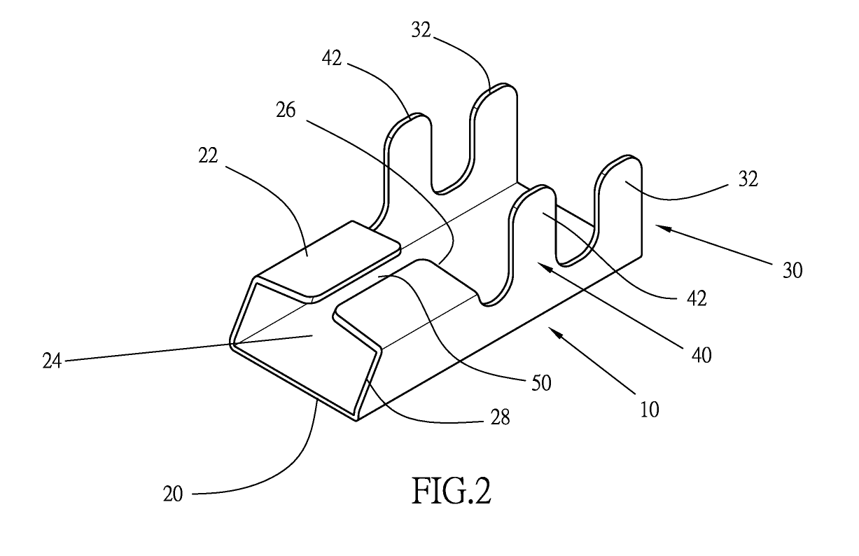

As shown in FIG. 2, the buckle 10 has a base portion 20, a supporting portion 22, a passageway 24 between the base portion 20 and the supporting portion 22. At opposite ends of the passageway 24 are the first opening 26 and the second opening 28. In the present embodiment, the buckle 10 is made by a bent plate. Opposite sides of the plate are bent upwards to form two sidewalls, and the base portion 20 is formed between the sidewalls. Next, front portions of the sidewalls are bent inwards to form the supporting portion 22. Therefore, a substantial rectangular pipe is formed, and a top side of the rectangular pipe is the supporting portion 22, and a bottom side thereof is the base portion 20.

The buckle 10 further has a first pressing portion 30 and a second pressing portion 40 behind the supporting portion 22, and the second pressing portion 40 is more proximal to the first opening 26 of the passageway 24. In the present embodiment, the first pressing portion 30 has two upright first protrusions 32, and the second pressing portion 40 has two second protrusions 42 on the sidewalls respectively. Precisely, the sidewalls each is cut to form a recess, and at opposite sides of the recess are the first and the second protrusions 32, 42.

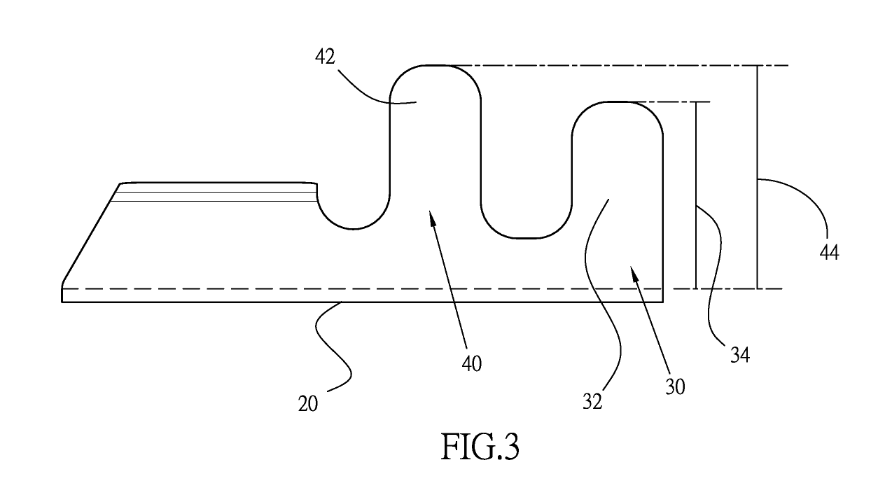

As shown in FIG. 3, a first distance 34 is defined between a distal end of the first protrusion 32 and the base portion 20, and a second distance 44 is defined between a distal end of the second protrusion 42 and the base portion 20. The second distance 44 is greater than the first distance 34.

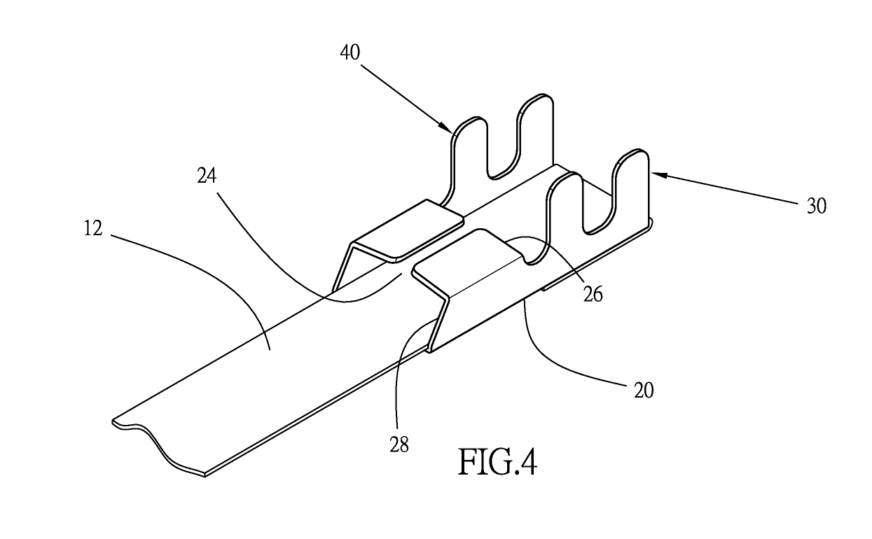

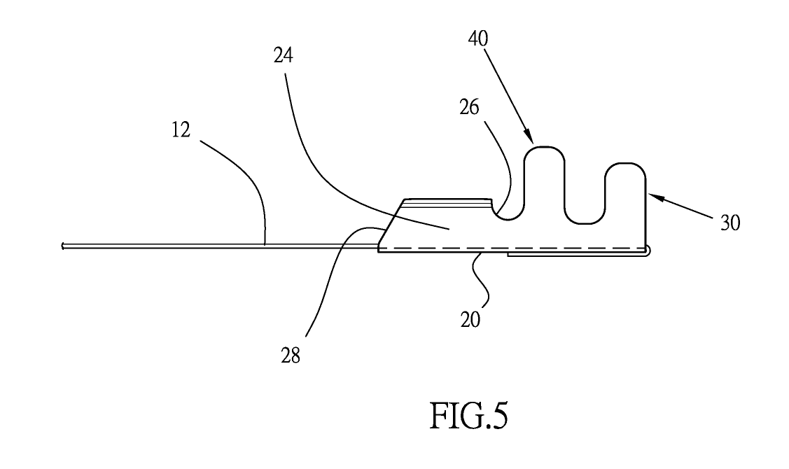

As shown in FIG. 4 and FIG. 5, the fastening strip 12 has an end connected to the base portion 20 of the buckle 10. In the present embodiment, the fastening strip 12 passes through the passageway 24, the second pressing portion 40, and the first pressing portion 30 in sequence, and is attached on a top side of the base portion 20. Next, the fastening strip 12 is bent downwards for 180 degrees to attach the distal end of the fastening strip 12 to a bottom side of the base portion 20.

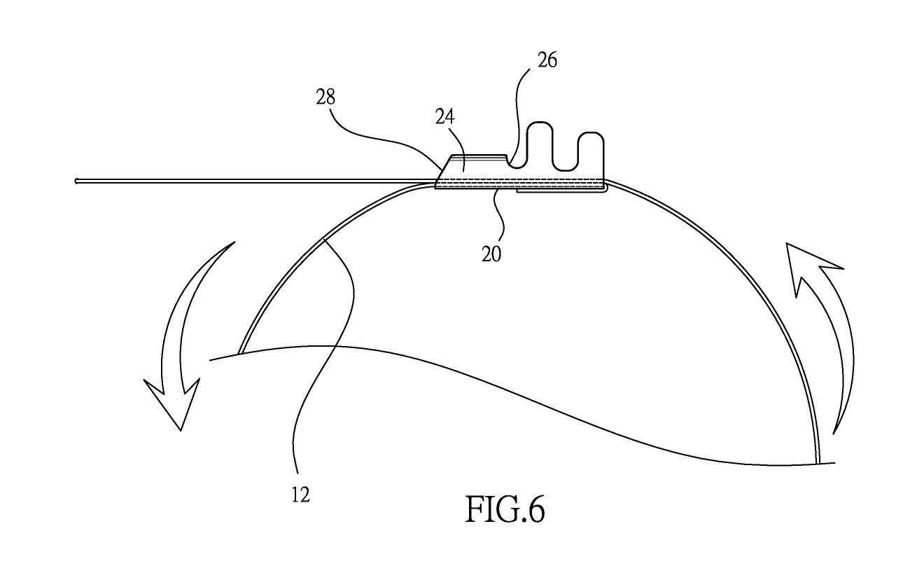

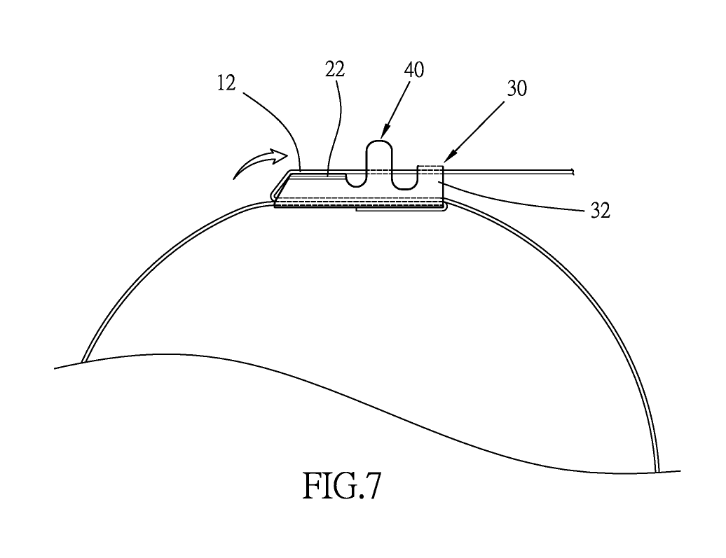

As shown in FIG. 6, next, an opposite end of the fastening strip 12 winds around the pipes and to the opposite end of the buckle 10, and then the fastening strip 12 passes through the first pressing portion 30, the second pressing portion 40, and the passageway 24 in sequence, and extends out of the buckle 10 via the second opening 28. As shown in FIG. 7, the fastening strip 12 now has to be bent upwards for 180 degrees to be attached to a top side of the supporting portion 22, and then passes through the second pressing portion 40 and the first pressing portion 30 in sequence. Next, the first protrusions 32 of the first pressing portion 30 are bent inwards to press the fastening strip 12 thereunder.

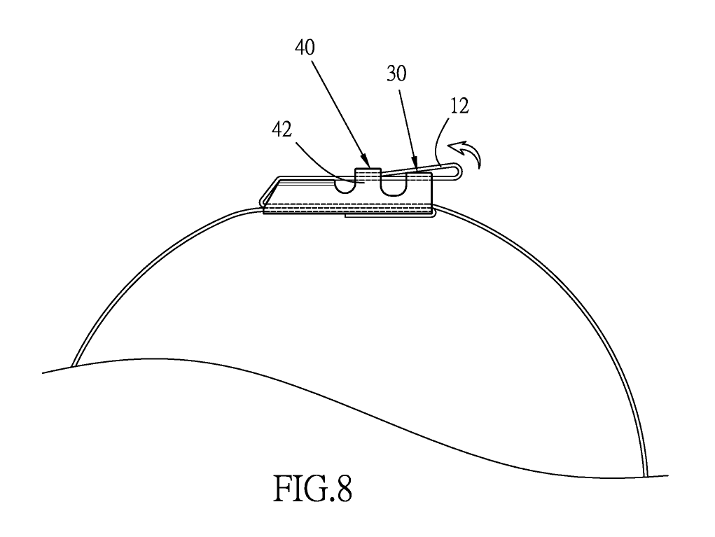

As shown in FIG. 8, the fastening strip 12 is bent upwards for 180 degrees to be attached to bent portions of the first protrusions 32 of the first pressing portion 30 and passes through the second pressing portion 40, and then the second protrusions 42 of the second pressing portion 40 are bent inwards to press the fastening strip 12 thereunder. As a result, the fastening strip 12 is secured to the buckle 10.

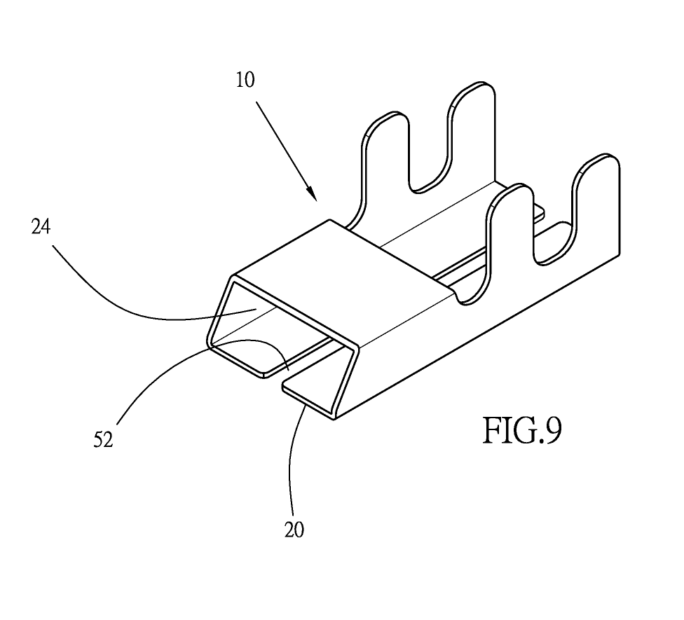

As shown in FIG. 2, when the front portions of the sidewalls are bent inwards to form the supporting portion 22, a gap 50 is formed between distal ends of the front portions of the sidewalls. The gap 50 extends in a direction parallel to the passageway 24. As shown in FIG. 9, a buckle 10 of the second referred embodiment of the present invention is formed by a bent plate. However, the plate of the second preferred embodiment is bent in a direction opposite to the first preferred embodiment, so that a gap 52 is formed on the base portion 20 instead.

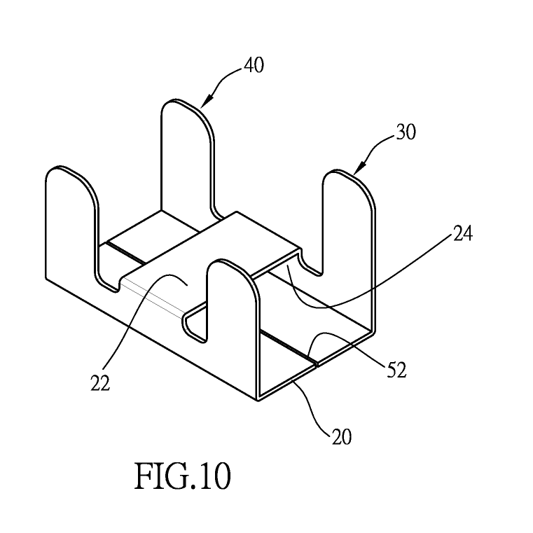

FIG. 10 shows a buckle 10 of the third preferred embodiment of the present invention, which is similar to the second preferred embodiment, except that the supporting portion 22 is formed between the first pressing portion 30 and the second pressing portion 40.

It must be pointed out that the embodiments described above are only some preferred embodiments of the present invention. All equivalent structures which employ the concepts disclosed in this specification and the appended claims should fall within the scope of the present invention.

What is claimed is:

1. A buckle, which is adapted to secure a fastening strip as a loop, comprising:
a base portion;
a supporting portion, which is above the base portion, wherein a passageway is formed between the base portion and the supporting portion, and the passageway has a first opening and a second opening at opposite ends thereof;
a first pressing portion connected to the base portion; and
a second pressing portion connected to the base portion;
wherein an end of the fastening strip is connected to the base portion, and an opposite end of the fastening strip passes through the passageway and winds around a good and arrives at an opposite ends of the buckle; next, the fastening strip passes through the buckle, and is attached on the supporting portion, and then the fastening strip is bent for 180 degrees to pass the buckle again, and the first pressing portion is bent to press the fastening strip thereunder, and then the fastening strip is bent for 180 degrees again to pass the buckle, and the second pressing portion is bent to press the fastening strip thereunder.

2. The buckle of claim 1, wherein the first pressing portion includes two first protrusions, and the first protrusions are projected from opposite sides of the base portion; the second pressing portion includes two second protrusions, and the second protrusions are projected from opposite sides of the base portion.

3. The buckle of claim 1, wherein a first distance is defined between a distal end of the first pressing portion and the base portion, and a second distance is defined between a distal end of the second pressing portion and the base portion; the second distance is greater than the first distance.

4. The buckle of claim 1, wherein the supporting portion has a gap extending in a direction parallel to the passageway.

5. The buckle of claim 1, wherein the base portion has a gap extending in a direction parallel to the passageway.

6. The buckle of claim 1, wherein the second pressing portion is between the supporting portion and the first pressing portion.

7. The buckle of claim 1, wherein the supporting portion is between the first pressing portion and the second pressing portion.
